(19) United States
(12) Patent Application Publication
(10) Pub. No.: US 2011/0076594 A1
(43) Pub. Date: Mar. 31, 2011

(54) Ceria-based electrolytes in solid oxide fuel cells

(76) Inventors: Zeng Fan, Stanford, CA (US); Friedrich B. Prinz, Woodside, CA (US); Ushio Harada, Wako-shi (JP)

(21) Appl. No.: 12/924,469

(22) Filed: Sep. 27, 2010

Related U.S. Application Data
(60) Provisional application No. 61/277,926, filed on Sep. 30, 2009.

(51) Int. Cl. H01M 8/10

(52) U.S. Cl. 429/489; 429/488

(57) ABSTRACT

A solid oxide fuel cell is provided having a ceria-based bulk electrolyte layer, an interface layer, an anode and a cathode, where the ceria-based bulk electrolyte layer is disposed between the cathode and the interface layer, and the interface layer is disposed between the ceria-based bulk electrolyte layer and the anode. Use of the ceria-based bulk electrolyte layer and an interface layer between the bulk layer and the anode takes advantage of the properties of a Ceria-based electrolyte without reducing to Ce (III) when operating the SOFC at the prescribed temperatures. The ceria-based bulk electrolyte layer has a thickness in a range of 10 nm to 500 um, and the interface layer has a thickness in a range of 1 angstrom to 50 nm.

### CROSS-REFERENCE TO RELATED APPLICATIONS

This application claims priority from U.S. Provisional Patent Application 61/277926 filed Sep. 30, 2009, which is incorporated herein by reference.

### FIELD OF THE INVENTION

This invention relates generally to solid oxide fuel cells. In particular, the invention relates to electrolyte structures suitable for low temperature solid oxide fuel cells (SOFC).

### BACKGROUND OF THE INVENTION

Solid oxide fuel cells (SOFCs) generally include three layers: anode, electrolyte and cathode. Yttria stabilized zirconia (YSZ) is the traditional electrolyte material for SOFCs due to its stability and relative high oxygen ion conduction at the elevated temperatures (above 700 C). Gadolinia and Yttria doped Ceria (GDC/YDC) have higher oxygen diffusivity and oxygen ion surface exchange rate than YSZ. A SOFC having a Ceria-based electrolyte has been thought to give better fuel cell performance than those of YSZ at lower temperatures, for example below 500° C. However, Ce (IV) potentially reduces to Ce (III) at the anode side of SOFC, which makes the electrolyte unstable and restricts the effective oxygen ion diffusion length.

FIG. 1 shows a schematic drawing of a prior art SOFC 100 having a cathode 102 on top of an oxide material layer 104 such as YSZ, GDC, etc. having a thickness that is typically is smaller than a few nm, with a bulk YSZ layer 106 having a thickness in the range of 60 nm to 1 um, which is disposed on top of an anode layer 108.

What is needed is a SOFC that takes advantage of the properties of a Ceria-based electrolyte without reducing to Ce (III) when operating the SOFC at the prescribed temperatures.

### SUMMARY OF THE INVENTION

To overcome the shortcomings in the art, a solid oxide fuel cell is provided having a ceria-based bulk electrolyte layer, an interface layer, an anode and a cathode, where the ceria-based bulk electrolyte layer is disposed between the cathode and the interface layer, and the interface layer is disposed between the ceria-based bulk electrolyte layer and the anode.

In one aspect of the invention, the ceria-based bulk electrolyte layer is made from material that can include gadolinium-doped ceria, yttria doped ceria, or ceria doped oxide.

In another aspect of the invention, the interface layer includes yittria stabilized zirconia (YSZ).

In a further aspect of the invention, the ceria-based bulk electrolyte layer has a thickness in a range of 10 nm to 500 um.

According to one aspect of the invention, the interface layer has a thickness in a range of 1 angstrom to 50 nm.

In yet another aspect of the invention, the ceria-based bulk electrolyte layer is deposited using atomic layer deposition.

According to another aspect of the invention, the interface layer is deposited using atomic layer deposition.

### BRIEF DESCRIPTION OF THE DRAWINGS

FIG. 1 shows a schematic drawing of a prior art SOFC.

FIG. 2 shows a schematic drawing of the solid oxide fuel cell having a ceria-based bulk electrolyte layer, according to one embodiment of the current invention.

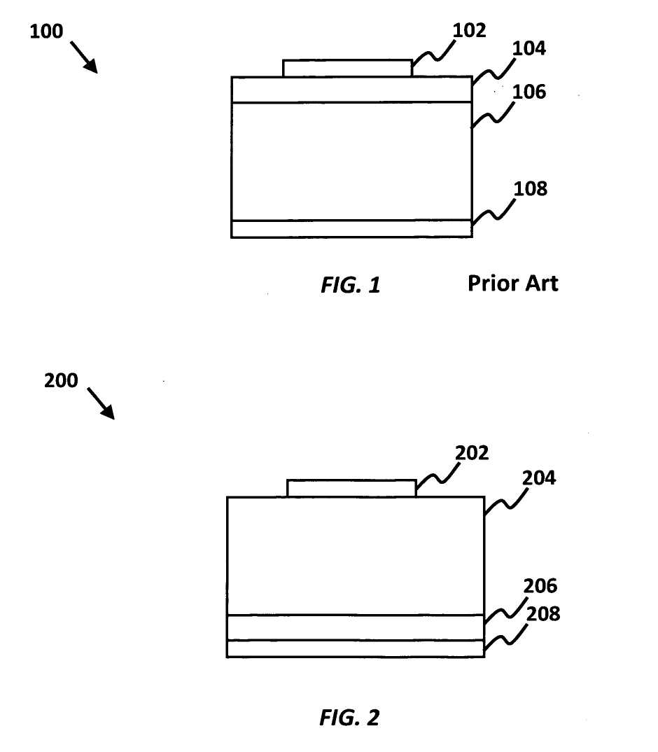

### DETAILED DESCRIPTION

Yttria doped Ceria (YDC) and Gadolinia doped Ceria (GDC) materials in a fuel cell possess higher oxide ion conductivities/diffusivities than Yttria stabilized zirconia (YSZ) material. According to one embodiment of the invention, use of bulk Ce-based films (like YDC, GDC, etc.) instead of bulk YSZ for the application of bi-layered electrolyte

SOFCs nCe-based films are provided by use of atomic layer deposition (ALD). Inserting interlayers of YSZ films between the bulk GDC/YDC electrolyte and anode materials stabilizes the whole electrolyte structure, while taking advantage of the better conductivity and high oxygen surface exchange rate of GDC/YDC. Thus the overall performance of this type of SOFCs is greatly enhanced.

According to one embodiment of the invention, the thickness of the GDC/YDC films can range from 10 nm to 500 μm, while the thickness of YSZ film ranges from about 1 angstrom to 50 nm. By providing GDC/YDC as the bulk electrolyte, the interfacial resistance is reduced at the cathode-side and the oxygen ion conduction for the bulk material is enhanced. By inserting at least one YSZ thin film between the GDC/YDC electrolyte and the anode, the stability of the whole electrolyte structure is increased.

In another aspect of the invention, devices with varying thickness ratios of YSZ and GDC/YDC layers are constructed. Further, other oxide ions besides GDC/YDC may also be used.

Referring again to the figures, FIG. 2 shows a schematic drawing of the solid oxide fuel cell 200 having a cathode layer 202, a ceria-based bulk electrolyte layer 204, an interface layer 206, and an anode layer 208, where the ceria-based bulk electrolyte layer 204 is disposed between the cathode layer 202 and the interface layer 206, and the interface layer 206 is disposed between the ceria-based bulk electrolyte layer 204 and the anode layer 208.

In one aspect of the invention, the ceria-based bulk electrolyte layer 204 is made from material that can include GDC, YDC, or ceria doped oxide.

In another aspect of the invention, the interface layer 206 includes YSZ.

In a further aspect of the invention, the ceria-based bulk electrolyte layer 204 has a thickness in a range of 10 nm to 500 um.

According to one aspect of the invention, the interface layer 206 has a thickness in a range of 1 angstrom to 50 nm.

In yet another aspect of the invention, the ceria-based bulk electrolyte layer 204 is deposited using ALD.

According to another aspect of the invention, the interface layer 206 is deposited using ALD.

The present invention has now been described in accordance with several exemplary embodiments, which are intended to be illustrative in all aspects, rather than restrictive.

Thus, the present invention is capable of many variations in detailed implementation, which may be derived from the description contained herein by a person of ordinary skill in the art. For example the invention can include vary the thickness ratio of YSZ and GDC/YDC layers or use of other oxide ion materials besides GDC/YDC.

All such variations are considered to be within the scope and spirit of the present invention as defined by the following claims and their legal equivalents.

What is claimed:

1. A solid oxide fuel cell, comprising:
a. a ceria-based bulk electrolyte layer;
b. an interface layer;
c. an anode; and
d. a cathode, wherein said ceria-based bulk electrolyte layer is disposed between said cathode and said interface layer, wherein said interface layer is disposed between said ceria-based bulk electrolyte layer and said anode.

2. The solid oxide fuel cell of claim 1, wherein said ceria-based bulk electrolyte layer is made from material selected from group consisting of gadolinium-doped ceria, yttria doped ceria, and ceria doped oxide.

3. The solid oxide fuel cell of claim 1, wherein said interface layer comprises yittria stabilized zirconia (YSZ).

4. The solid oxide fuel cell of claim 1, wherein said ceria-based bulk electrolyte layer has a thickness in a range of 10 nm to 500 um.

5. The solid oxide fuel cell of claim 1, wherein said interface layer has a thickness in a range of 1 angstrom to 50 nm.

6. The solid oxide fuel cell of claim 1, wherein said ceria-based bulk electrolyte layer is deposited using atomic layer deposition.

7. The solid oxide fuel cell of claim 1, wherein said interface layer is deposited using atomic layer deposition.
